(19) United States
(12) Patent Application Publication
(10) Pub. No.: US 2024/0120760 A1
(43) Pub. Date: Apr. 11, 2024

(54) METHOD FOR CHARGING AN ELECTRICAL ENERGY STORAGE DEVICE, ELECTRICAL ENERGY MANAGEMENT SYSTEM AND COMPUTER PROGRAM PRODUCT FOR CARRYING OUT THE METHOD, AND USE THEREOF

(71) Applicant: Siemens Aktiengesellschaft, MÜnchen (DE)

(72) Inventors: Alexander Polleti, Nabburg (DE); Arno Arzberger, Stegaurach (DE); Kilian Scheer, Bad Staffelstein (DE); Jonas Witt, Nürnberg (DE)

(21) Appl. No.: 18/370,169

(22) Filed: Sep. 19, 2023

(30) Foreign Application Priority Data
Sep. 29, 2022 (EP) 22198735.7

(51) Int. Cl. H02J 7/00; G01N 27/42; H01M 10/44; H01M 10/48

(52) U.S. Cl. CPC H02J 7/00712; G01N 27/423; H01M 10/44; H01M 10/48; H02J 7/0048

(57) ABSTRACT

A method, a system and a computer program product for changing an electrical state of charge of an electrical energy storage:
a) stipulating at least one target value for a target state of charge of the electrical storage device,
b) determining at least one actual value of an actual state of charge of the electrical storage device,
c) extrapolating the actual value of the actual state of charge of the energy storage device to an extrapolation value of an extrapolation state of charge of the energy storage device, taking into account at least one charging parameter of the charging process, and
d) comparing the target value of the target state of charge with the extrapolation value of the extrapolation state of charge and starting or interrupting the charging process if the extrapolation value deviates from the target value by more than 2%.

### CROSS-REFERENCE TO RELATED APPLICATIONS

This application claims priority to EP Application No. 22198735.7, having a filing date of Sep. 29, 2022, the entire contents of which are hereby incorporated by reference.

### FIELD OF TECHNOLOGY

The following relates to a method for changing an electrical state of charge (charging) of an electrical energy storage device, to an electrical energy management system and to a computer program product for carrying out the method. In addition, the use of the method, the electrical energy management system or the computer program product is specified.

### BACKGROUND

In high precision coulometry (HPC), a Coulomb efficiency is determined by cyclizing an electrical energy storage device in the form of a battery cell. This involves repeatedly charging and discharging the battery cell between two previously stipulated voltage limits (target states of charge of the battery cell).

For the Coulomb efficiency to be qualitative and significant, it is important that these two voltage limits are adhered to exactly. To meet the exact limit voltages and the time between charging the battery cell and discharging the battery cell, the present voltage (actual value of the actual state of charge) of the battery cell needs to be measured.

The real actual value of the cell voltage may differ from the measured actual value of the cell voltage, however. The measurement may be distorted due to fluctuations in a charging current. These fluctuations can be both stochastic and periodic.

This means that interrupting the charging process (switching at the desired time), which in turn depends on a precisely defined voltage limit, is not guaranteed.

### SUMMARY

An aspect relates to show how the interruption (or starting) of the charging process of an electrical energy storage device can be triggered as exactly as possible.

The aspect is achieved by specifying a method for changing an electrical state of charge of an electrical energy storage device by way of at least one charging process, in which electrical energy is supplied to the electrical energy storage device or in which electrical energy is removed from the electrical energy storage device. The following method steps are performed:
a) stipulating at least one target value for a target state of charge of the electrical storage device,
b) determining at least one actual value of an actual state of charge of the electrical storage device;
c) extrapolating the actual value of the actual state of charge of the energy storage device to an extrapolation value of an extrapolation state of charge of the energy storage device, taking into account at least one charging parameter of the charging process, and
d) comparing the target value of the target state of charge with the extrapolation value of the extrapolation state of charge and starting or interrupting the charging process if the extrapolation value deviates from the target value by more than 2%.

It is advantageous if actual values of multiple actual states of charge are determined (measured). This means that at least one further determination of a further actual value of at least one further actual state of charge is carried out. The further actual value of the further actual state of charge is used for the extrapolation in addition to the actual value of the state of charge.

The deviation is selected from the range from 5% to 50% and in particular from the range from 5% to 20%. A deviation from these ranges results in the charging process being started or interrupted.

The aspect is also achieved by specifying an electrical energy management system for carrying out the method, having a means for stipulating the target value of the target state of charge of the electrical energy storage device, a means for determining the actual value of the actual state of charge of the electrical energy storage device, a means for extrapolating the actual value of the actual state of charge to the extrapolation value of the extrapolation state of charge, a means for comparing the actual value of the actual state of charge with the extrapolation value of the extrapolation state of charge and a means for starting or interrupting the charging process if the extrapolation value of the extrapolation state of charge deviates from the target value of the target state of charge by more than 2%.

In addition, the aspect is also achieved by specifying a computer program product (non-transitory computer readable storage medium having instructions, which when executed by a processor, perform actions for the electrical energy management system, wherein the computer program product has at least one means from the following group: means for stipulating the target value of the target state of charge of the electrical energy storage device, means for determining the actual value of the actual state of charge of the electrical energy storage device, means for extrapolating the actual value of the actual state of charge to the extrapolation value of the extrapolation state of charge, means for comparing the actual value of the actual state of charge with the extrapolation value of the extrapolation state of charge and means for interrupting the charging process. The computer program product can be used to carry out the method (or at least one of the method steps) in a computer-aided manner. The charging involves charging the energy storage device or discharging the electrical energy storage device. A specific charging current can be supplied to the energy storage device for charging. A specific charging current can drain to discharge the energy storage device.

The target value is a setpoint value at which the charging process is started or interrupted. For example, the setpoint value is a voltage limit (final value of the cell voltage) that needs to be observed to ascertain the Coulomb efficiency, mentioned at the beginning. The setpoint value is thus a limit state of charge.

In one particular embodiment, the determination of the actual value of the actual state of charge is carried out during the charging process. This allows the charging process to be checked and, if necessary, also interrupted at any time. However, it is also advantageous to determine the actual value of the actual state of charge during a rest phase of the energy storage device and then, if necessary, to start charging the energy storage device.

The extrapolation involves using an extrapolation time range that is between an actual time at which the determination of the actual value of the actual state of charge is carried out and an extrapolation time for which the extrapolation value of the extrapolation state of charge is ascertained, and that is selected from the range from 1 ms to 1 s and in particular from the range from 50 ms to 500 ms.

An electrical capacitor (e.g., electrolytic capacitor) is conceivable as the electrical energy storage device. In particular, a battery is used as the electrical energy storage device. The battery (electrochemical energy storage device) has at least one battery cell that is used to convert electrical energy into chemical energy during charging and chemical energy into electrical energy during discharging. For this purpose, a specific amount of electricity is supplied to the battery or battery cell when charging and a specific amount of electricity is taken away (removed) from the battery or battery cell when discharging.

A rechargeable battery (storage battery) is used as the battery. The charging process here is at least approximately reversible. A wide variety of storage batteries can be used for this purpose, for example a sodium-ion storage battery or a nickel metal hydride storage battery.

In one particular embodiment, a lithium-ion battery (lithium-ion storage battery) is used as the rechargeable battery. Lithium-ion batteries are distinguished by a relatively high energy density and by a relatively high charging efficiency.

Any real-world extrapolation model can be used for the extrapolation. In one particular embodiment, a linear extrapolation model with linear regression of the actual value to the extrapolation value is used for the extrapolation. For this purpose a linear relationship between a static charging current used for the charging process and a store voltage of the electrical energy storage device that changes during the charging process is used. Such an extrapolation model is relatively simple. Such an extrapolation model provides very good results as well. A forecast of the time at which charging ends can be made reliably.

In one particular embodiment, a linear relationship between a static charging current used for the charging process and a store voltage of the electrical energy storage device that changes during the charging process is used for the linear extrapolation model.

A wide variety of charging parameters can be used to extrapolate the actual value of the actual state of charge to the extrapolation value of the extrapolation state of charge. In particular, this involves using at least one variable selected from the group comprising material of the energy storage device, structure of the energy storage device, charging capacity of the energy storage device, temperature of the energy storage device and moisture in an environment of the energy storage device. For example, the material relates to electrode material or electrolyte material of the battery. For example, the structure relates to the nature of the electrodes (surface or thickness of an electrode). For example, the temperature refers to the instantaneous actual temperature of the energy storage device.

According to another aspect of embodiments of the invention, the method, the electrical energy management system or the computer program product are used in high precision coulometry.

### BRIEF DESCRIPTION

Some of the embodiments will be described in detail, with reference to the following FIGURES, wherein like designations denote like members, wherein:

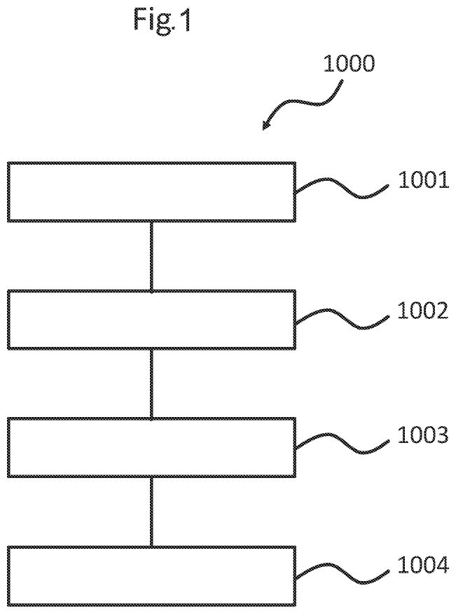

FIG. 1 shows a method for changing an electrical state of charge of an electrical energy storage device.

### DETAILED DESCRIPTION

According to the exemplary embodiment, a lithium-ion battery (lithium-ion storage battery) is used as the electrical energy storage device. To change 1000 the state of charge (voltage state) of the lithium-ion battery, that is to say to charge or discharge the lithium-ion battery, the following method steps are carried out:
a) stipulating 1001 a target value for a target state of charge of the electrical storage device;
b) determining 1002 at least one actual value of an actual state of charge of the electrical storage device;
c) extrapolating 1003 the actual value of the actual state of charge of the energy storage device to an extrapolation value of an extrapolation state of charge of the energy storage device, taking into account at least one charging parameter of the charging process; and
d) comparing the target value of the target state of charge with the extrapolation value of the extrapolation state of charge and starting or interrupting the charging process if the extrapolation value deviates from the target value by approximately 5% (1004).

The method is carried out using an electrical energy management system. The electrical energy management system is computer-aided and is carried out using a computer program product.

The computer program product has the following means:
means for stipulating the target value of the target state of charge of the lithium-ion battery,
means for determining the actual value of the actual state of charge of the lithium-ion battery,
means for extrapolating the actual value of the actual state of charge to the extrapolation value of the extrapolation state of charge,
means for comparing the actual value of the actual state of charge with the extrapolation value of the extrapolation state of charge and
means for starting or interrupting the charging process.

A linear extrapolation model with linear regression of the actual value of the actual state of charge to the regression value of the regression state of charge is used for the extrapolation. A linear relationship between a static charging current used for the charging process and a store voltage of the lithium-ion battery that changes during the charging process is used for the linear extrapolation model. The charging parameters used include the temperature of the lithium-ion battery energy storage device and the humidity of an environment of the lithium-ion battery.

Multiple actual values of multiple actual states of charge of the lithium-ion battery (measurement points) are measured for the method.

The intervals of time between the individual measurement points are the same. This allows them to be standardized. A regression is then conducted over the last N values. For this, y(x) is the raw measurement signal at time x.

$$\overline{x} = \frac{1}{N} {\sum }_{x = 0}^{N - 1} x = \frac{N - 1}{2}$$

$$\overline{y} = \frac{1}{N} {\sum }_{x = 0}^{N - 1} y ( x )$$

$$\hat{b} = \frac{{\sum }_{x = 0}^{N - 1} ( x - \overline{x} ) * ( y ( x ) - \overline{y} )}{{\sum }_{x = 0}^{N - 1} {( x - \overline{x} )}^{2}} = \frac{{\sum }_{x = 0}^{N - 1} ( x - \overline{x} ) * ( y ( x ) - \overline{y} )}{\frac{1}{12} ( {N}^{2} - 1 ) * N}$$

$$\hat{a} = \overline{y} - ( \hat{b} * \overline{x} )$$

By creating a model by means of linear regression, the correct time at which the battery cell reaches its setpoint voltage is found. For example, the influencing variable used is the mean value of the last 1024 measurement points of the voltage, and the target variable (target value of the target state of charge) defined is the setpoint voltage. Switching therefore takes place not in a voltage-controlled manner and therefore on the basis of a measurement, but rather in a software-based manner. The linear regression uses the linear relationship between static current and rising cell voltage.

The method is used in high precision coulometry.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for changing an electrical state of charge of an electrical energy storage device by way of at least one charging process, in which electrical energy is supplied to the electrical energy storage device or in which electrical energy is removed from the electrical energy storage device, having the following method steps:
a) stipulating a target value for a target state of charge of the electrical storage device;
b) determining at least one actual value of an actual state of charge of the electrical storage device;
c) extrapolating the actual value of the actual state of charge of the energy storage device to an extrapolation value of an extrapolation state of charge of the energy storage device, taking into account at least one charging parameter of the charging process; and
d) comparing the target value of the target state of charge with the extrapolation value of the extrapolation state of charge and starting or interrupting the charging process if the extrapolation value deviates from the target value by more than 2%.

2. The method as claimed in claim 1, wherein the deviation is selected from the range from 5% to 50% or from the range from 5% to 20%.

3. The method as claimed in claim 1, wherein the determination of the actual value of the actual state of charge is carried out during the charging process.

4. The method as claimed in claim 1, wherein the extrapolation involves using an extrapolation time range that
is between an actual time at which the determination of the actual value of the actual state of charge is carried out and an extrapolation time for which the extrapolation value of the extrapolation state of charge is ascertained, and
that is selected from the range from 1 ms to 1 s and or from the range from 50 ms to 500 ms.

5. The method as claimed in claim 1, wherein a battery is used as the electrical energy storage device.

6. The method as claimed in claim 5, wherein a rechargeable battery is used as the battery.

7. The method as claimed in claim 6, wherein a lithium-ion battery is used as the rechargeable battery.

8. The method as claimed in claim 1, wherein a linear extrapolation model with linear regression of the actual value of the actual state of charge to the extrapolation value of the extrapolation state of charge is used for the extrapolation.

9. The method as claimed in claim 8, wherein a linear relationship between a static charging current used for the charging process and a store voltage of the electrical energy storage device that changes during the charging process is used for the linear extrapolation model.

10. The method as claimed in claim 1, wherein the charging parameter used is at least one variable selected from the group comprising material of the energy storage device, structure of the energy storage device, charging capacity of the energy storage device, temperature of the energy storage device and moisture in an environment of the energy storage device.

11. An electrical energy management system for carrying out a method as claimed in claim 1, having
a means for stipulating the target value of the target state of charge of the electrical energy storage device,
a means for determining the actual value of the actual state of charge of the electrical energy storage device,
a means for extrapolating the actual value of the actual state of charge to the extrapolation value of the extrapolation state of charge,
a means for comparing the actual value of the actual state of charge with the extrapolation value of the extrapolation state of charge and
a means for starting or interrupting the charging process if the extrapolation value of the extrapolation state of charge deviates from the target value of the target state of charge by more than 2%.

12. A computer program product, comprising a computer readable hardware storage device having computer readable program code stored therein, said program code executable by a processor of a computer system to implement a method for an electrical energy management system as claimed in claim 11, wherein the computer program product has at least one means selected from the following group:
means for stipulating the target value of the target state of charge of the electrical energy storage device,
means for determining the actual value of the actual state of charge of the electrical energy storage device,
means for extrapolating the actual value of the actual state of charge to the extrapolation value of the extrapolation state of charge,
means for comparing the actual value of the actual state of charge with the extrapolation value of the extrapolation state of charge and
means for starting or interrupting the charging process.

13. The use of a method as claimed in claim 1.

14. The use of the electrical energy management system as claimed in claim 11.

15. The use of the computer program product as claimed in claim 12 in high precision coulometry.
